(19) United States
(12) Patent Application Publication
(10) Pub. No.: US 2005/0162320 A1
(43) Pub. Date: Jul. 28, 2005

(54) Antenna of electronic device

(75) Inventors: Chi-Fang Huang, Taipei (TW); Jer-Ming Chen, Taipei (TW)

Correspondence Address: BACON & THOMAS, PLLC, 625 SLATERS LANE, FOURTH FLOOR, ALEXANDRIA, VA, 22314, US

(73) Assignee: QuadRep Electronics (T) Ltd., Taipei Hsien (TW)

(21) Appl. No.: 10/761,195

(22) Filed: Jan. 22, 2004

(51) Int. Cl. H01Q 1/24

(52) U.S. Cl. 343/702

(57) ABSTRACT

The present invention is to provide an antenna of an electronic device wherein an actuation member is disposed on a surface of a case of the electronic device the actuation member being operative to project from the case, a portion of an antenna module is enclosed by the actuation member so as to project such portion of the antenna module from the case for transmitting or receiving signals, a remaining portion of the antenna module is disposed within the case, and a distal end of the antenna module is coupled to a wireless transmission/reception module within the case. Since the portion of the module projected from the case is no more shielded by the case, the electronic device will then always have a good signal transmission/reception capability.

### FIELD OF THE INVENTION

The present invention relates to antennas and more particularly to an antenna of an electronic device (e.g., notebook computer, desktop computer or the like) with improved characteristics.

### BACKGROUND OF THE INVENTION

Electronics industry and information technology have known a rapid, spectacular development in recent years. Further, the development of network (e.g., the Internet) has made it possible of being employed by a great number of families, schools, and companies. Such greatly changes the conventional communications, lifts the restraint imposed due to the nature of time and space, and brings more convenience to our daily life. Further, a variety of portable electronic products (e.g., notebook computers, PDAs (Personal Digital Assistants), or the like) are widely used nowadays. A user of such electronic product may not only want an increased data transfer rate over the Internet but also want to access the Internet in any time any place without having to find a modular wall jack to plug in prior to accessing the Internet. For meeting the above need, a WLAN (wireless local area network) is commercially available.

WLAN is characterized in that an electronic product may operate in cooperation with an access point to establish a wireless Internet connection via a wireless network adapter (e.g., Wireless card, CF (Compact Flash) card, PCI (Peripheral Component Interconnect) Express card, or PCMCIA (Personal Computer Memory Card International Association) card). Data is transferred by means of electromagnetic wave. Next, a wireless bridge is adapted to receive transmitted data prior to sending to a coupled network connection. Finally, a user of the electronic product is able to access the Internet for retrieving information from millions of sources.

Nowadays, wireless, wideband online is very popular throughout the world. For example, similar services are provided in many international airports, restaurants, hotels, coffee shops, etc. A user may install a wireless network card in his/her notebook computer or PDA. Next, type a user name and a password provided by an ISP (Internet service provider) to log on. If success, the user may access the Internet to retrieve information from millions of sources. Internet access via WLAN has the following advantages:

(1) A connection between a computer and the Internet is not restrained by the fixed location of a network cable. (2) It is not restrained by the specifications of a network cable and a modular wall jack. Hence, time, labor, and cost spent on establishing a network connection are saved. (3) Data transfer rate of a wireless bridge is 11 Mbps as stipulated by IEEE 802.11b protocol. That is, it is about 200 times of 56 Kbps achievable by a typical modem. It can successfully satisfy the need of large file transfer. Moreover, an updated IEEE 802.11g protocol having a data transfer rate of 54 Mbps has been stipulated in July, 2003. (4) It is possible of adding new users to access the Internet without being limited by the number of network connecting nodes.

Conventionally, an antenna is mounted in the case of an electronic product capable of accessing the Internet wirelessly. For achieving a better signal transmission/reception, the antenna is mounted in the case (e.g., corner of LCD (liquid crystal display) of a notebook computer). The desired signal transmission/reception capability cannot be obtained if the antenna is completely mounted within the case. Further, the extent of signal decay is varied depending on the material of the case. In a typical example, the case made of alloy can cause a maximum extent of signal decay when an antenna is transmitting or receiving signal. For solving this problem, a telescopic antenna mounted on the case is proposed by some notebook computer manufacturers. The telescopic antenna is able to transmit or receive signal with less decay. As such, it can successfully solve the problem of poor transmission/reception due to the shielding of antenna by the case. However, a new mold is required to prepare prior to manufacturing a new case. This inevitably will increase the manufacturing and assembly costs. Also, an antenna projected from the case may impose a restraint on the design (i.e., appearance) of the case.

In view of the above, it is found that a projecting antenna has the benefit of achieving an increased signal transmission/reception capability but has the disadvantages of being visually unaesthetic and increasing the manufacturing and assembly costs. In another case an antenna mounted in the case, a shielding effect can be obtained. However, it is poor in signal transmission/reception. This is a dilemma for installing an antenna in the wireless electronic product. Thus, it is desirable to provide an antenna capable of achieving a good signal transmission/reception capability while without modifying the design of the case of a wireless electronic product.

### SUMMARY OF THE INVENTION

An object of the present invention is to provide an antenna of an electronic device wherein an actuation member is disposed on a surface of a case of the electronic device, the actuation member being operative to project from the case, a portion of an antenna module is enclosed by the actuation member so as to project such portion of the antenna module from the case for transmitting or receiving signals, a remaining portion of the antenna module is disposed within the case, and a distal end of the antenna module is coupled to a wireless transmission/reception module within the case. By configuring the present invention as a portion of the antenna module projected from the case without being shielded by the case, it is possible of achieving a good signal transmission/reception of the antenna module without modifying the existing appearance of the case.

The above and other objects, features and advantages of the present invention will become apparent from the following detailed description taken with the accompanying drawings.

### BRIEF DESCRIPTION OF THE DRAWINGS

FIG. 1 is a perspective view of an antenna mounted in an electronic device according to the invention;

FIG. 2 is a perspective view of the antenna mounted in a PCMCIA slot according to the invention; and

FIG. 3 is an exploded perspective view of the antenna mounted in a floppy disk drive according to the invention.

### DETAILED DESCRIPTION OF THE PREFERRED EMBODIMENTS

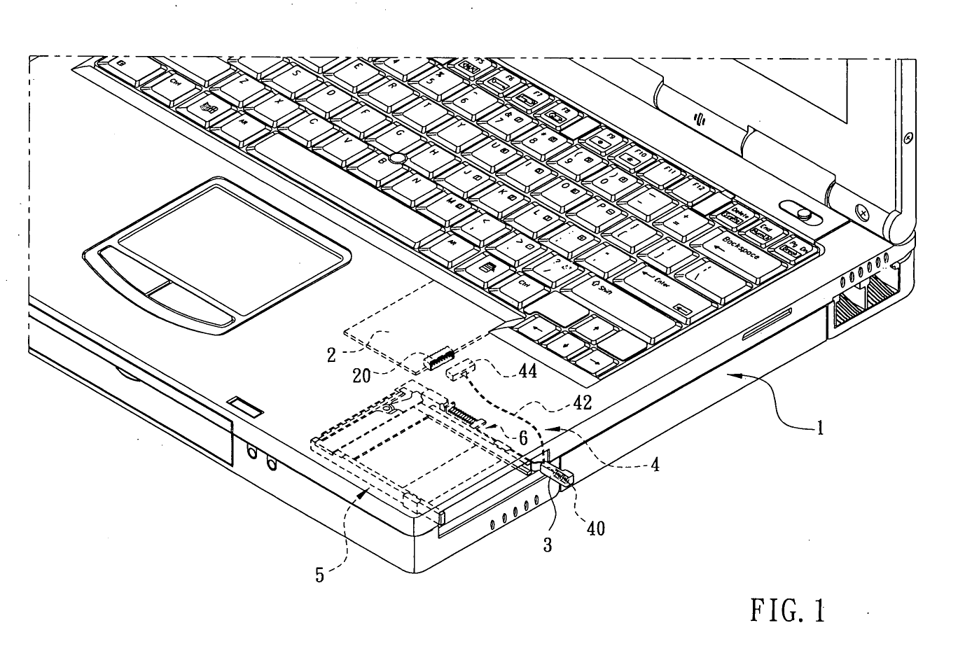

Referring to FIG. 1, there is shown an antenna of an electronic device in accordance with the invention. As shown, a wireless transmission/reception module 2 is provided in a case 1 of the electronic device. An actuation member 3 is provided on the surface of the case 1. In operation, the actuation member 3 is adapted to project from or retract into the case 1. There is also provided an antenna module 4 having a portion located in the actuation member 3. The antenna module 4 is interconnected one projecting end of the actuation member 3 and the wireless transmission/reception module 2. The antenna module 4 in the actuation member 3 will not be shielded by the case 1 since the actuation member 3 is projected from the case 1. As such, a good signal transmission/reception of the antenna module 4 can be obtained in which received signals are sent to the wireless transmission/reception module 2 for further processing or signals are sent from the wireless transmission/reception module 2 to the antenna module 4 for transmission. In addition, the appearance of the case 1 can be maintained since the antenna module 4 is provided within the actuation member 3.

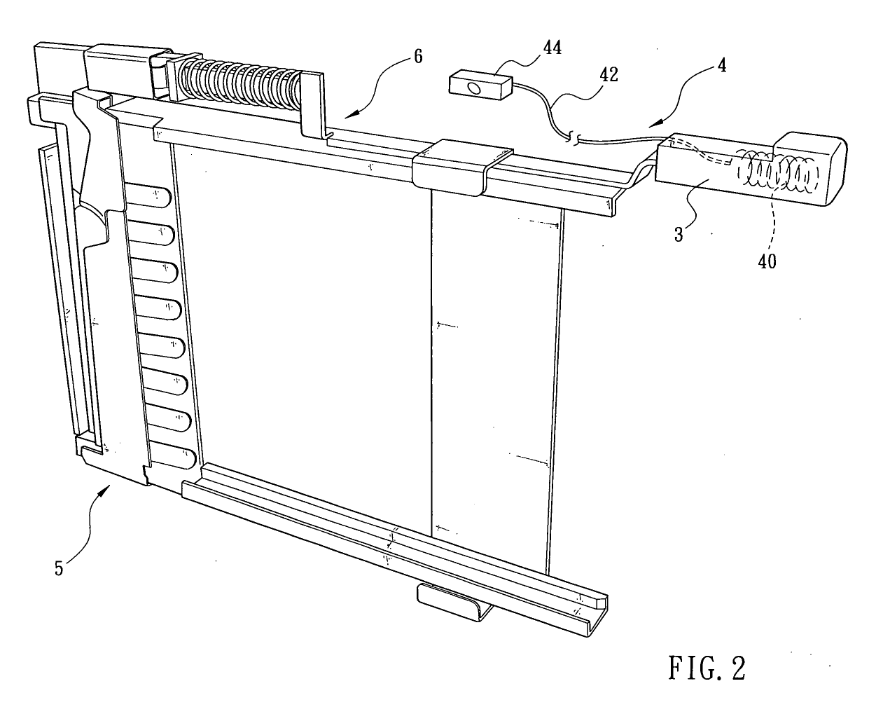

Referring to FIG. 2 in conjunction with FIG. 1, a preferred embodiment of the invention is illustrated. The antenna module 4 comprises a body 40, a cable 42, and a connector 44 in which the body 40 is provided in the actuation member 3, one end of the cable 42 is coupled to the body 40, the other end of the cable 42 is coupled to the connector 44, and the connector 44 is coupled to another connector 20 of the wireless transmission/reception module 2. Hence, signals received by the body 40 are sent to the wireless transmission/reception module 2 via the cable 42 and the connector 44 for further processing.

Referring to FIG. 1 again, an embodiment is described for further understanding the practice of the invention. In the invention, the electronic device is implemented as a notebook computer having a PCMCIA or PCI Express slot 5. The PCMCIA or PCI Express slot 5 is adapted to receive a PCMCIA or PCI Express card (not shown) by insertion. A card removal mechanism 6 is provided adjacent the PCMCIA or PCI Express slot 5. The actuation member 3 is coupled to one end of the card removal mechanism 6. The actuation member 3 is projected from the case 1 of the notebook computer. The card removal mechanism 6 is operated in response to the state of whether the PCMCIA or PCI Express card is inserted into the PCMCIA or PCI Express slot 5 or not. For example, the actuation member 3 will project from the case 1 when the card removal mechanism 6 is activated in response to the insertion of the PCMCIA or PCI Express card into the PCMCIA or PCI Express slot 5. As such, a user can press the actuation member 3. Once the actuation member 3 is pressed, the card removal mechanism 6 activates to reject the PCMCIA or PCI Express card from the PCMCIA or PCI Express slot 5. In other words, one end of the card removal mechanism 6 will project from the case 1 or not in response to the state of whether the PCMCIA or PCI Express card is inserted into the PCMCIA or PCI Express slot 5 or not.

It is apparent from the above that the actuation member 3 is projected from the case 1 in a non-operating state of the PCMCIA or PCI Express slot 5. Also, the actuation member 3 is enclosed by a plastic block member at one end of the card removal mechanism 6. Hence, the body 40 will not be shielded by the case 1 if the body 40 is provided in the block member. As a result, a good signal transmission/reception of the antenna module 4 can be obtained. Moreover, the PCMCIA slots 5 are widely employed in various electronic products. Particularly, many notebook computer manufacturers like to adopt it. As such, it is common to install a PCMCIA slot in a notebook computer, PDA, or tablet PC (personal computer) since it is a practical and popular electrical component. The actuation member 3, associated with the card removal mechanism 6 and integrally formed within the body 40, is a unique characteristic of the invention since such has the benefits of being appropriately shielded, aesthetic, and obtaining a good signal transmission/reception capability.

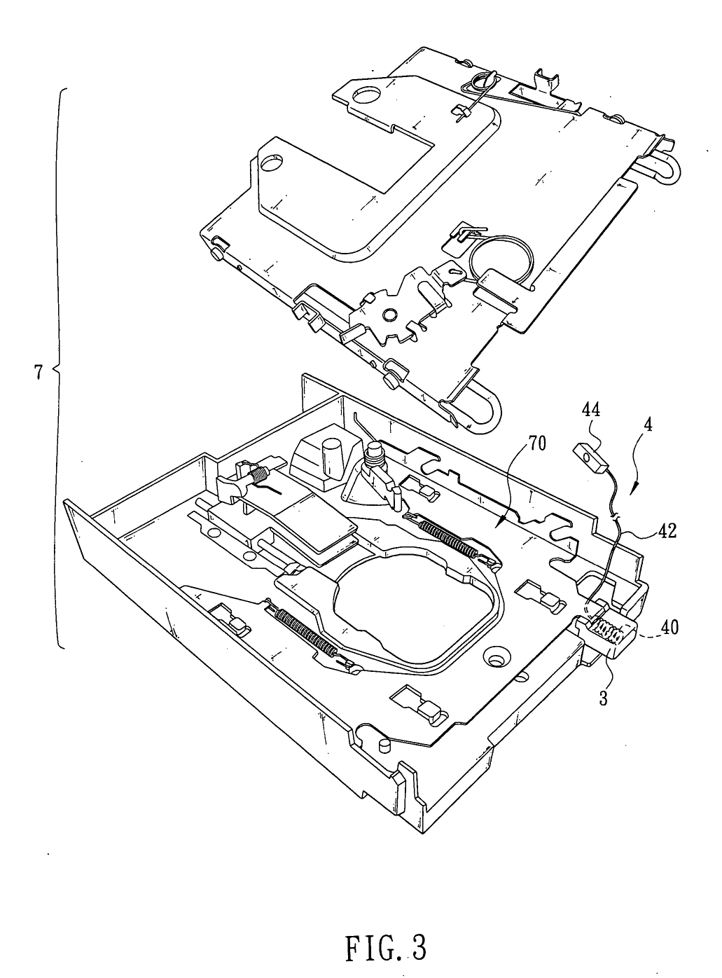

Moreover, in the invention the electronic device is implemented as a desktop computer or notebook computer. A floppy disk drive 7 is typically mounted in the computer. In use, a user can insert a floppy disk into the floppy disk drive 7 for reading/writing data. Referring to FIG. 3, a disk removal mechanism 70 is also provided in the floppy disk drive 7. One end of the disk removal mechanism 70 is projected from the case 1 irrespective of a floppy disk being inserted into the floppy disk drive 7 or not. For example, one end of the disk removal mechanism 70 will project from the case 1 in response to the insertion of a floppy disk into the floppy disk drive 7. As such, a user can press one end of the disk removal mechanism 70 to reject the floppy disk from the floppy disk drive 7. That is, one end of the disk removal mechanism 70 will project from the case 1 or not in response to the state of whether the floppy disk is inserted into the floppy disk drive 7 or not. The actuation member 3 is provided within one end of the disk removal mechanism 70 (i.e., projected from the case 1). Also, the body 40 is provided in the actuation member 3, resulting in a shielding of the antenna module 4 by the case 1.

In other embodiments, the actuation member 3 may be provided in any locations other than at one end of the card removal mechanism 6 or the disk removal mechanism 70. For example, the actuation member 3 can be provided in a button or knob (e.g., power switch) on the case 1 as long as the body 40 is mounted therein without being shielded by the case 1, and signal transmission/reception is not adversely affected thereby. The wireless transmission/reception module 2 is implemented as a GSM (Global System for Mobile), GPRS (General Packet Radio Service), or CDMA (Code Division Multiple Access) wireless transmission/reception module.

By configuring as above, that is, the body 40 is mounted in the actuation member 3 and the actuation member 3 is projected from the case 1 to dispose in an existing projecting element of the case 1, the invention can achieve a good signal transmission/reception without modifying the design (i.e., appearance) of the case 1.

While the invention has been described by means of specific embodiments, numerous modifications and variations could be made thereto by those skilled in the art without departing from the scope and spirit of the invention set forth in the claims.

1. An antenna of an electronic device, comprising:
a case;
a wireless transmission/reception module mounted in the case;
an actuation member disposed on a surface of the case, the actuation member being operative to control an activation of an element mounted on the case; and
an antenna module having a portion disposed in the actuation member, the antenna module being interconnected one projecting end of the actuation member and the wireless transmission/reception module.

2. The antenna of claim 1, wherein the antenna module comprises:
a body disposed in the actuation member;
a cable having one end coupled to the body; and
a connector coupled to the other end of the cable, the connector being adapted to couple to a second connector on the wireless transmission/reception module.

3. The antenna of claim 1, wherein the case is the case of a notebook computer.

4. The antenna of claim 1, wherein the case is the case of a desktop computer.

5. The antenna of claim 1, wherein the actuation member is a button on the case with the body being is mounted therein.

6. The antenna of claim 1, wherein the wireless transmission/reception module is a GSM, a GPRS, or a CDMA wireless transmission/reception module.

7. The antenna of claim 3, wherein the notebook computer comprises a PCMCIA slot being adapted to receive a PCMCIA card by insertion, further comprising a card removal mechanism being disposed adjacent one side of the PCMCIA slot wherein one end of the card removal mechanism is coupled to the actuation member.

8. The antenna of claim 3, wherein the notebook computer comprises a PCI Express slot being adapted to receive a PCI Express card by insertion, further comprising a card removal mechanism being disposed adjacent one side of the PCI Express slot wherein one end of the card removal mechanism is coupled to the actuation member.

9. The antenna of claim 3, wherein the notebook computer comprises a floppy disk drive including a disk removal mechanism having one end coupled to the actuation member.

10. The antenna of claim 4, wherein the desktop computer comprises a floppy disk drive including a disk removal mechanism having one end coupled to the actuation member.

11. The antenna of claim 7, wherein the actuation member is adapted to project from the case or not in response to inserting a PCMCIA card into the PCMCIA slot or not.

12. The antenna of claim 8, wherein the actuation member is adapted to project from the case or not in response to inserting a PCI Express card into the PCI Express slot or not.
